(19) United States
(12) Patent Application Publication
(10) Pub. No.: US 2007/0039563 A1
(43) Pub. Date: Feb. 22, 2007

(54) Dog leash and control apparatus

(76) Inventor: Ernst Keller, Sunnyvale, CA (US)

Correspondence Address: BUCHANAN, INGERSOLL & ROONEY PC, POST OFFICE BOX 1404, ALEXANDRIA, VA, 22313-1404, US

(21) Appl. No.: 11/209,955

(22) Filed: Aug. 22, 2005

(51) Int. Cl. A01K 27/00

(52) U.S. Cl. 119/799

(57) ABSTRACT

A dog training and control apparatus including an elongated walking wand having a distraction end and a handle end, and at least two leash receiving guide rings, a first of which is attached to the wand proximate the handle end, and a second of which is attached to the wand along a mid portion of the length thereof, whereby a leash can be strung through the guide rings, with one end of the leash being secured to the wand, and a distal end of the leash being attachable to the collar of a dog to be trained, such that a handler gripping the wand at the handle end can use the leash to restrain the dog in a heeling position, and can use the distraction end to distract the dog should it attempt to move forward of the heeling position or focus its attention on another dog or object. A hand receiving safety loop is provided at the handle end of the wand to assist the user in holding the assembly.

### FIELD OF THE INVENTION

The present invention relates generally to apparatus of the type used to train dogs, and more particularly to an improved dog training and control assembly that facilitates the training of a dog to walk beside its handler, to dissuade the dog from focusing its attention on another dog or object that might cause it to become excited, and allows better dog control and protection for the handler than prior art devices, yet permits all of the dog-to-handler freedom of movement afforded by other leash devices.

### BACKGROUND OF THE INVENTION

Dogs that are constrained to live in populated neighborhoods must be trained to adhere to acceptable standards of behavior. Specifically, the dogs must be trained to obey commands such as sit, stay, lie down, come, and heel. The animal must also be trained to stop barking and not to run away from or jump up onto its handler or others with whom it comes in contact. By jumping on its handler or others the dog might knock the person down, or soil the person's clothes. Training a rambunctious dog or puppy to keep all four paws on the ground, or to stop the almost out of control, high pitch barking or screaming that some small breeds do when excited, can however, be a difficult and frustrating task, and in the past has usually required use of a choke or shock collar.

Most of the above listed commands are easily taught using a flexible leash that will not break under tension. In particular, training the dog to come, and preventing it from running away, can be accomplished with a flexible leash that will not break in response to pulling by the animal. A flexible leash is desirable while casually strolling because the dog is most content when its collar is not under tension and when it is allowed some freedom to wander within several feet of its handler. However, outside the training sessions, and during simple walks, these leash characteristics are often undesirable. For example, a flexible leash is of little use in separating the dog from another dog in the case of a fight.

In further contrast, some of the above listed commands are not easily accomplished with a flexible leash but instead require the handler to physically direct or otherwise force the animal to respond to the command. In particular, during training of the animal not to jump, the handler is sometimes required to bend over toward the animal, grab the animal's collar or harness, and pull or push the animal toward the ground. This places the owner's face within biting distance of the animal and, ironically, tends to further encourage the animal to jump or otherwise respond. Moreover, grasping the collar of a jumping and squirming puppy may be difficult to accomplish. Similarly, in teaching a dog to heel, the dog usually must be physically positioned relative to the handler, at least during the early part of the training session, so that it learns the expected positional relationship to the handler required in response to the heel command. A flexible leash makes such training difficult.

In the case of a screaming dog, no manner of restraint short of throttling or choking with a choke collar seems to work to silence the animal; only removal or distraction of the animal, or removal of the exciting source will end the episode.

Accordingly, a flexible leash does not readily facilitate the training of an animal to heel, stop jumping or stop screaming. However, a flexible leash may be desired during the remainder of a training session. There is thus a need for an animal training device that allows a handler to distract or exert physical control over the dog during part of the training session, yet has the benefit of a flexible leash during other parts of the session.

Many different forms of leash apparatus and related devices have been used in the past to assist dog handlers in training dogs. Typical leashes allow the handler to either hold the dog up close or permit the dog to move a short distance away from the handler. But one can readily observe that most dogs, and particularly the larger species, when being walked, tend to move ahead of the handler and sometimes pull on the leash in a manner that makes it difficult for the handler to maintain control. In order to keep the dog at the handler's side, he has to shorten up the leash and in some cases extend his hand and arm behind his back in order to maintain the dog by his side. This is obviously an awkward and inconvenient manner of control. As indicated above, in the case of a screaming smaller dog, sometimes the only practical way to calm the dog and stop the screaming is to remove it from the source or provide some type of distraction.

There is thus a need for a training and control mechanism and assembly that allows the dog handler to conveniently position the dog at his side and at the same time encourages the dog to stay in position and not move ahead during the walk. There is also a need to provide an implement that can be used to assist the owner in separating his dog from another dog in the event of a conflict with another dog. There is also a further need to provide a means for avoiding the screaming episodes of small dogs.

### SUMMARY OF THE INVENTION

It is therefore an object of the present invention to provide a dog training and control apparatus that can be used to control both large and small dogs as they are trained to walk alongside their owner.

Another object of the present invention is to provide an apparatus of the type described that allows a handler to take a proactive approach in avoiding dog misbehavior rather than simply reacting to it.

Yet another object of the present invention is to provide a means for preventing hyperactive dogs from getting into uncontrollable screaming situations.

A further object of the present invention is to provide an apparatus of the type described that can be used with standard retractable and non-retractable leashes to provide an assembly that will facilitate the training of a dog to “heel” or walk beside its owner.

Still another object of the present invention is to provide an apparatus of the type described that can be used to encourage a dog to walk slightly behind and to the side of its owner.

A still further object of the present invention is to provide an apparatus of the type described which enables an owner to both control the position of the dog and at the same time provide a distraction that will encourage the dog to walk in the desired relationship to its owner.

Briefly, a presently preferred embodiment of the present invention includes an elongated walking wand having a distraction end and a handle end, and at least two leash receiving guide rings, a first of which is attached to the wand proximate the handle end, and a second of which is attached to the wand at the opposite end or along a mid portion of the length thereof, whereby a leash can be strung through the guide rings with one end of the leash being secured to the wand, and the distal end of the leash being attachable to the collar of a dog to be trained. Thus, a handler gripping the wand at the handle end can use the leash to restrain the dog in a heeling position, and can use the distraction end to distract the dog should it attempt to move forward of the heeling position or become distracted. A hand receiving safety loop is provided at the handle end of the wand to assist the user in holding the assembly.

An important advantage of the present invention is that it provides a lightweight addition to a standard leash that allows the owner to both position the dog beside him and allow the dog to stray a short distance away.

Another advantage of the present invention is that it provides a means by which an owner can restrain his dog in a proper walking position without having to reach behind his back.

Still another advantage of the present invention is that it provides a means for distracting the dog should it attempt to move forward from the desired walking position. Yet another advantage of the present invention is that it provides a means for distracting a hyperactive dog so that it will not see and respond to other dogs and people with an uncontrollable screaming or high pitched barking action.

These and other objects and advantages will no doubt become apparent to these skilled in the art after having read the following detailed description which makes reference to the several figures of the drawing wherein

### BRIEF DESCRIPTION OF THE DRAWINGS

FIG. 1 is a side elevational view showing a walking wand and leash apparatus in accordance with the present invention;

FIG. 2 is a bottom plan view thereof;

FIG. 3 is a partially broken side view showing details of the attachment of a retractable leash device to a wand in accordance with the present invention;

FIG. 4 is a cross sectional view taken along the lines 4-4 in FIG. 3;

FIG. 5 is a top view showing how the retractable leash may be swiveled to one side of the wand;

FIG. 6 illustrates a Carabineer ring and its manner of attachment to the wand;

FIGS. 7-11 are views showing details of the noise maker shown in FIGS. 1 and 2;

FIGS. 12-16 are stick figures illustrating how one can use the subject invention to train his dog;

FIGS. 17, 18 and 19 illustrate an alternative form of safety strap; and

FIGS. 20 and 21 are perspective views illustrating alternative embodiments and features of walking wands and leash apparatus in accordance with the present invention.

### DETAILED DESCRIPTION

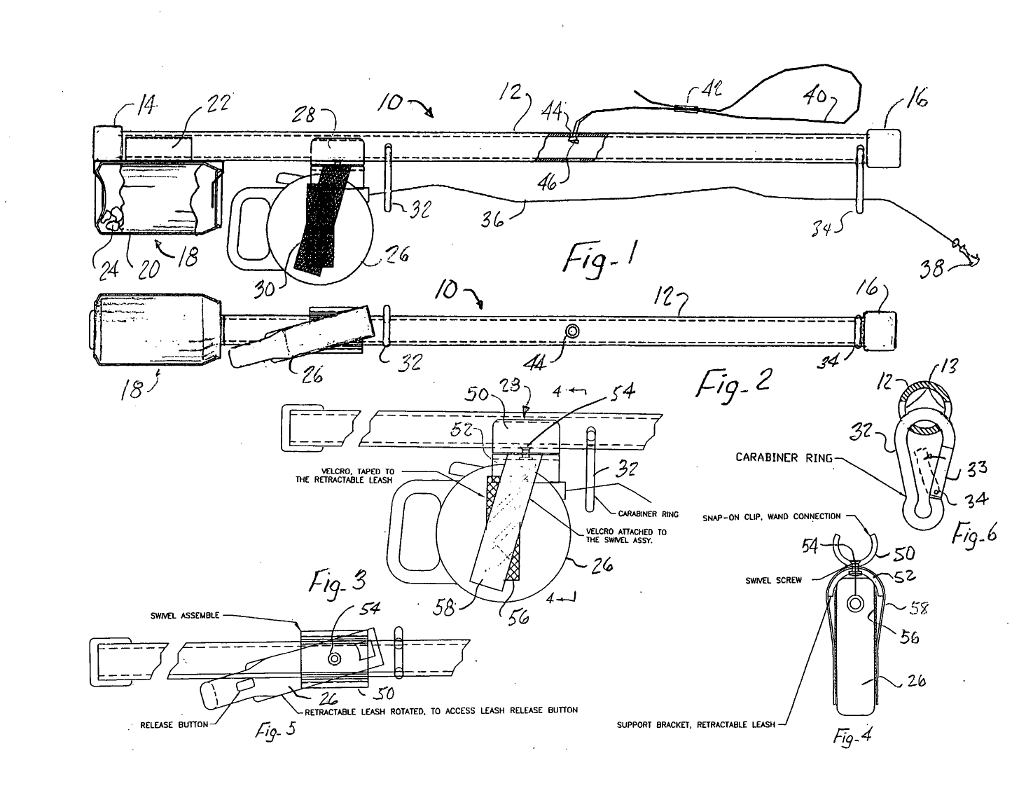

Referring now to the drawing, an embodiment of a “walking wand”, sometimes referred to as an “Alpha leash”, in accordance with the present invention is shown at 10 in an elevational or side view in FIG. 1 and in a bottom plan view in FIG. 2. As depicted, the device includes an elongated rod or tube forming a wand 12 having end caps 14 and 16 forming closures for each end of the tube. In a preferred embodiment the tubular wand 12 is approximately 2 feet in length and is made of PVC tubing, fiberglass, aluminum or other suitable materials. Affixed to the end portion of wand 12 and beneath the cap 14 is a rattle or other noise maker 18, the purpose of which will be explained below. This end of the assembly is referred to as the “distraction end” of the device. In the illustrated embodiment the rattle 18 is formed by a soda can 20 secured to the tube 12 by a suitable clip or other fastening means 22. Contained within can 20 are a plurality of small stones, beads or other objects 24 that will make noise when the can is shaken.

To the right of rattle 18, as depicted in FIGS. 1 and 2, is a commercially available, retractable dog leash 26 that is secured to tube 12 by a clip 28 and Velcro fastening strips 30. It will be appreciated however that a simple non-retractable leash could also be used with the walking wand. To the immediate right of leash 26 and also at to the distal end of tube 12 are Carabineer guide rings 32 and 34 that respectively serve as eyelets though which the dog leash 36 is threaded. A suitable clip 38 is affixed to the distal end of leash 36 for engaging a dog collar. Also secured to the top of tube 12, at the end referred to as the “handle end”, is a safety strap 40 having an adjustment buckle or grip 42 for allowing the user to avoid unintentional dropping of the wand should the dog bolt and attempt to run away, as after a squirrel, cat or another dog. Although numerous forms of strap can be used, that illustrated is a simple rope cloth or leather strap passed through a hole 44 in the tube 12 and having a knot 46 tied at its end.

In FIGS. 3-5 further detail of the second clip 28 reveal that the clip includes parts 50 and 52 pivotally secured together by a rivet or swivel screw 54 that allows the two parts to rotate relative to each other so that the leash housing 26 can be swiveled out to one side of the assembly to facilitate its use. Note that the leash assembly 26 is a commercially available unit that is held in place relative to clip part 52 Velcro strips 56 affixed to the housing 26 and a mating Velcro strip 58 that is secured to clip 52.

In FIG. 6 a Carabineer ring is depicted and shown passed through openings 13 in tube 12. The ring 32 includes a rigid, hook-shaped member and a short closure member pivotally secured at 34 and rotatable inwardly relative to member 32 as illustrated by the dashed lines, so as to open the ring and allow a leash to be threaded through it as shown in FIG. 1.

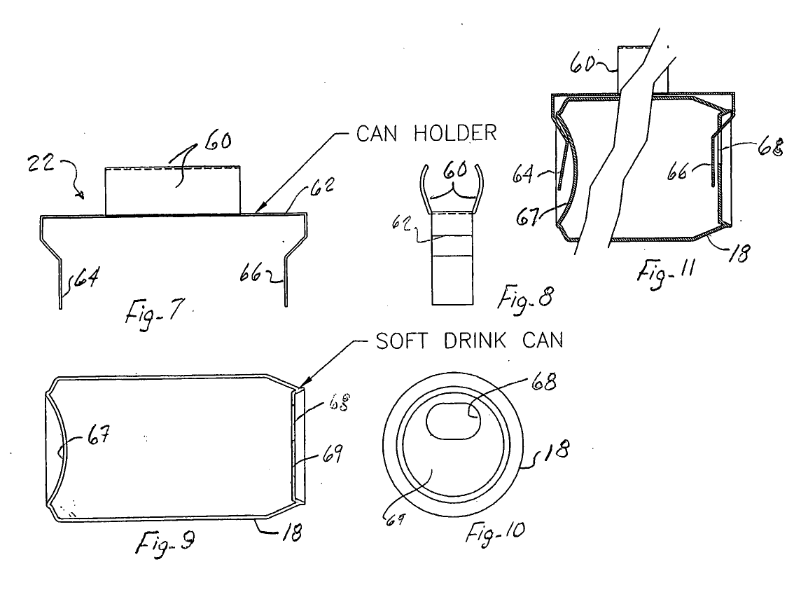

Turning now to FIGS. 7 and 8, details of the can clip are shown. This clip is made from a single piece of spring steel and cut to form a pair of upstanding ears 60 adapted to clip over the tube 12 as depicted in FIG. 1. The lower portion of clip 22 is an elongated tab 62 that is deformed as illustrated to include 2 inwardly and down turned legs 64 and 66 adapted to engage opposite ends of a drink can and hold it in place relative to the tube 12 (FIG. 1).

In FIG. 9 a longitudinal cross-section through the can 18 is shown revealing the concave lower end 67 and the flat but apertured upper end 69. In FIG. 10 an end view of the upper end 69 is shown with its opening 68. As illustrated in the assembly drawing of FIG. 11, it can be seen that by inserting the tab end 66 through the can opening 68, the lower end 67 can be snapped into engagement with the tab end 64 and the can will be securely held in place. Note also from FIGS. 8 and 10 that the width of the tab 62 is substantially equal to the width of the can opening 68 and thus forms a closure therefor that prevents the objects 24 (FIG. 1) from being discharged from the can.

Referring now to FIGS. 12-16, use of the illustrated embodiment of the subject invention will be discussed. In what I call the first position, the handler attaches the holding end of the leash 36 (in this case a non-retractable leash) to the wand by tying it to the ring 32 and threads it through the ring 34 and clips the distal end of the leash to the dog's collar. He then grips the wand at the handle end and begins walking with the dog by his side, and with the distracting end extending downwardly as shown. If the dog should attempt to move forward of the handler, he would merely place the distraction end near the dog's nose and shake it causing the pebbles in the can 18 to rattle. The combination of the wand end and the rattle will signify to the dog that he is not to move forward of the handler. Note that at this time the leash need not be pulled tight to restrain the dog as it will recognize the visual and audible communication provided by the distraction end of the wand.

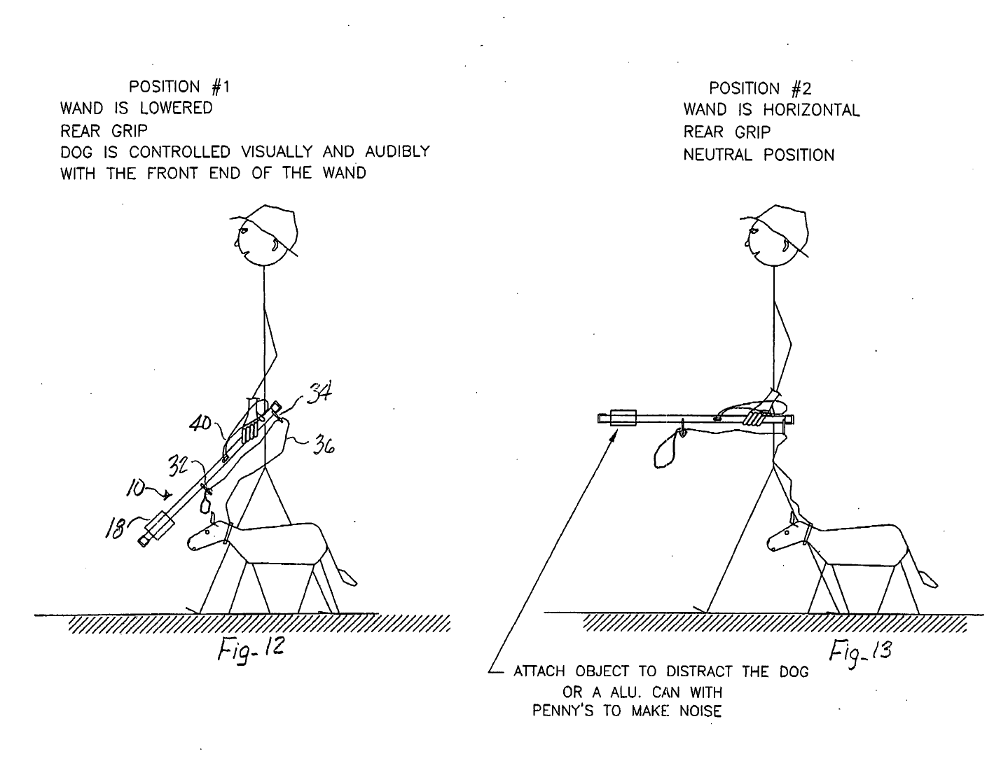

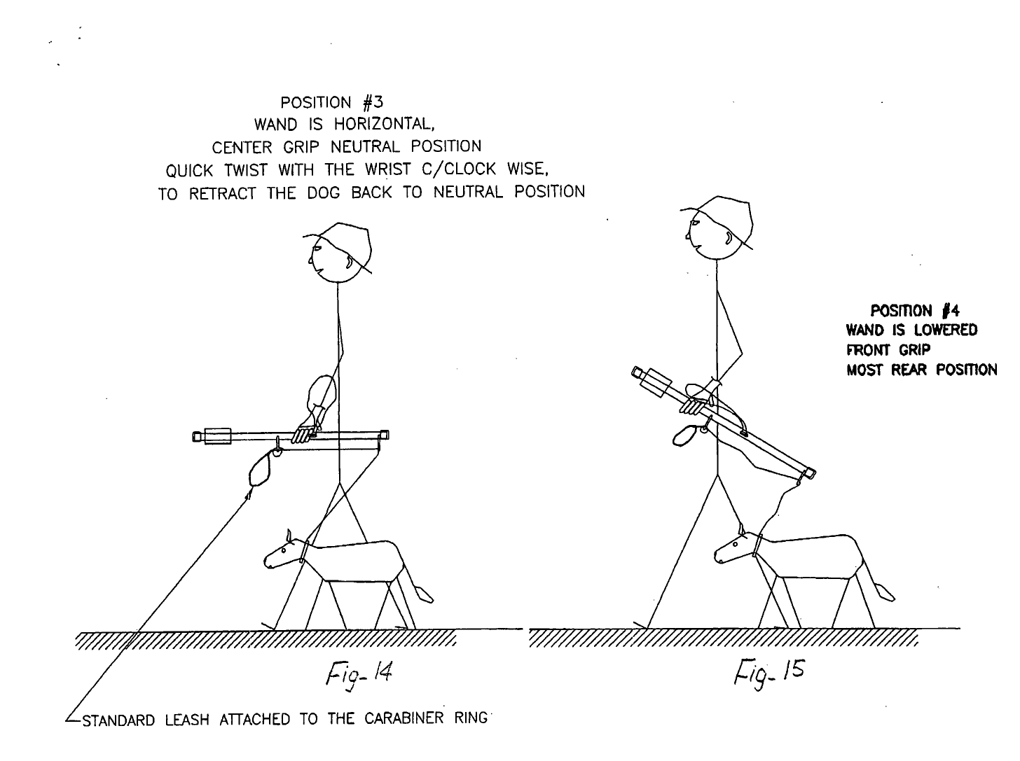

With the dog walking slightly behind the handler, the wand will be held substantially horizontal to the ground as illustrated in FIG. 13. Should the dog start to move forward relative to the handler, he will simply lower the distraction end of the wand and perhaps shake the rattle if it is needed. When the dog returns to the proper position the wand can be returned to the walking position of FIG. 13.

Should the dog not adequately respond to the lowering of the wand, then the handler can move his hand forward on the wand as illustrated in FIG. 14 and use the now tightened leash to restrain the dog and hold it in the walking position.

If the dog now walks in the desired, slightly behind position, the handler can slide his hand father forward on the wand as depicted in FIG. 15 and allow the handle end to lower and release the restraining force on the leash.

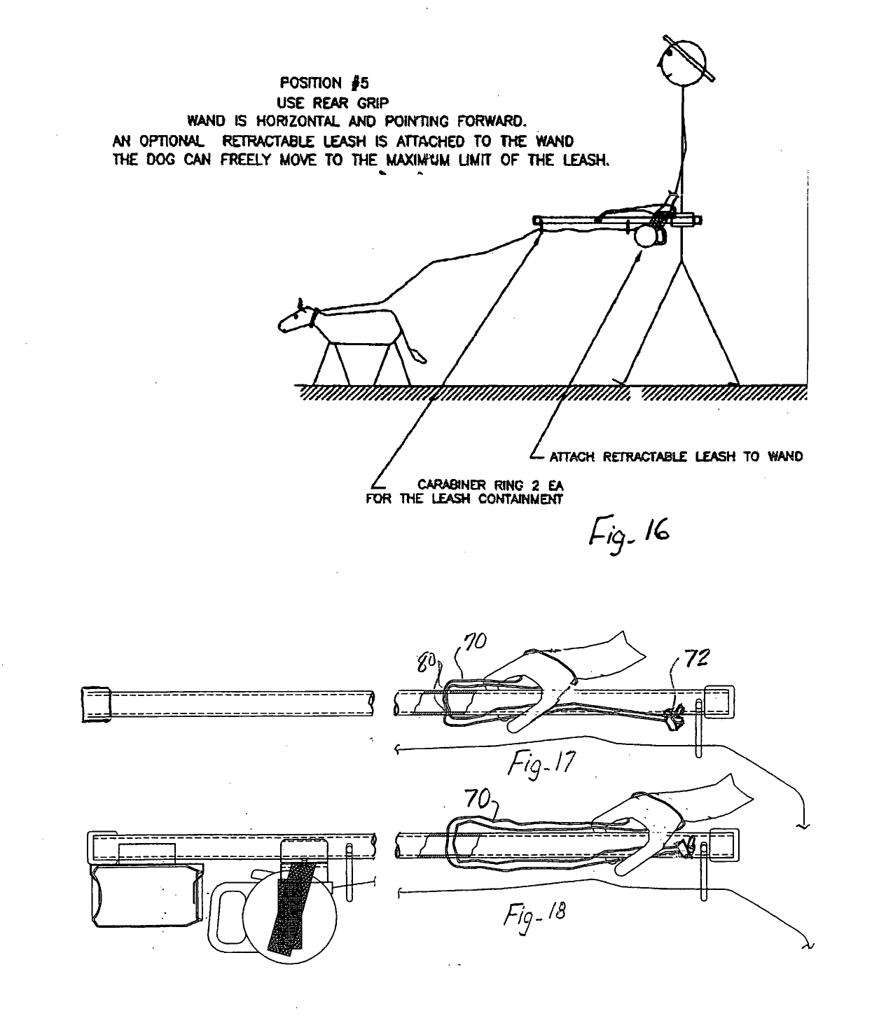

It will thus be appreciated that by using the walking wand, a handler can train a dog to heel without having to continually tighten his grip on the leash in order to restrain the dog and hold him in position. All that is required is a repositioning of the wand so as to distract the dog from his desire to move forward, perhaps coupled with a slight shaking of the rattle to provide a more dramatic distraction. It will also be appreciated that if a retractable leash is used with the walking wand, the handler can reverse the orientation of the wand so that the handle end extends forward, as shown in FIG. 16, and by gripping the wand at a point between the can and the retractable housing, the handler can play out the leash and allow the dog to walk ahead or to the side of the handler until he needs to return the dog to the heeling position at which time he reverse the direction of the wand and proceed as described above.

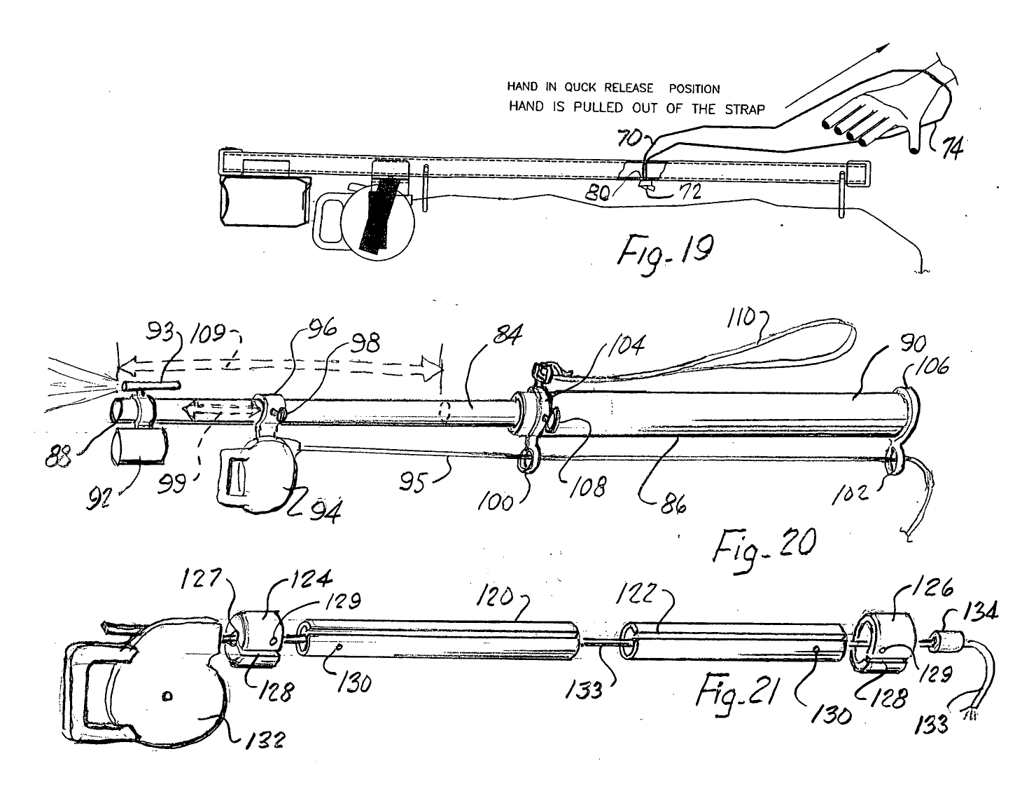

In FIGS. 17, 18 and 19 an alternative form of safety strap is depicted at 70. In this embodiment the strap 70 is not affixed to the wand but is instead merely looped back upon itself, passed through a transverse passageway formed by a pair of holes 80 in the wand, and a knot 72 is tied at its distal ends. The handler merely extends his hand through the loop, pulls the open ends of the strap snug and then, as depicted in FIG. 17, grips the wand with the knotted ends between his hand and the wand. If he wants to change his gripping position on the wand as shown in FIG. 18, he simply releases his grip, slides his hand into the new position tightening or loosening the strap as required, and then again grips both strap and wand. Should the dog bolt and begin to run with a pulling force greater than the handler can or desires to resist, he can simply release his grip and the strap will be pulled through the holes 80 until the knot 72 engages the wand, and the looped end 74 will be pulled from the handler's hand freeing him from the wand assembly.

In FIG. 20, another embodiment of a walking wand and leash apparatus is depicted. This embodiment differs from earlier described embodiments in that the wand portion of the device is made telescopic so that the length thereof can be selectively lengthened or shortened. In the illustrated device, the wand is comprised of a first tubular member 84 and a second tubular member 86, the outer diameter of the first member being slightly smaller than the inner diameter of the second member so that the first member can be telescopically received within the second member. Like the previously described embodiments, this embodiment includes a distraction end 88 and a handle end 90. And similarly, the distraction end is provided with a noise maker 92 that may include an electronic buzzer, a beeper or even a mild shocking probe to get and retain the dog's attention.

A small battery powered flashlight 93 may also be attached to the upper part of the collar to help illuminate the walkway as the handler walks the dog at night. The light will also make it easier for the handler to find and pickup dog droppings. Furthermore, as a safety measure, a part or all of the wand may be illuminated and/or coated with a reflective material.

This embodiment also includes a built-in retractable leash mechanism 94 that is selectively positionable along the member 84 to accommodate the telescopic collapsing of the wand. More specifically, the mechanism 94 is suspended from member 84 by a collared fixture 96 that is slideable along the member and fixable relative thereto by a thumbscrew 98.

In order to allow member 84 to slide into member 90 without obstruction, the guide rings 100 and 102 of this embodiment are integral parts of collars 104 and 106 that are attached to member 90 by epoxy or other suitable fastening means. The leash is extended through the rings or eyelets 100, 102 as in previous embodiments. In addition, collar 104 includes a thumbscrew 108 that extends through an underlying wall member 90 to engage and lock in position the member 84. Collar 104 also includes an upstanding projection forming an eyelet to which a safety strap 110 is attached. It will be understood that by releasing the thumbscrew 98 and sliding the mechanism 94 forward (leftwardly as illustrated) on member 84 as suggested by the dashed arrow 99, and by releasing the thumbscrew 108, the member 84 may be retracted into member 90 as suggested by the dashed arrow 109, so that the overall length of the wand can be adjusted to any length within the limits of arrow 109.

In FIG. 21 still another alternative embodiment of the present invention is depicted and comprised of an elongated tube 120 (shown broken in two for detail) having a slit 122 cut along one side thereof. At each end thereof are end caps 124 and 126, each having an axial opening 127 formed therein and a slit 128 extending through the side and end wall to the opening 127. When slipped over the ends of the tube 120 the end caps are held in place by the engagement of detents 130 with small holes 129 drilled in the caps. The purpose of the slits 122 and 128 is to allow a leash line 133 (from a retraction mechanism 132) to be inserted into the tube and end caps from the side. Specifically, with caps 124 and 126 installed over the tube ends, and with the cap slits 128 aligned with the tube slit 122, it will be appreciated that the leash line can be easily inserted through the slits and into position lying along the axis of the tube. The caps can then be rotated about tube 120 until the detents 129 lockingly engage the holes 129 at which time the line 133 will be installed within the tube and the wand is complete except for the possible attachment of a distraction means and a safety strap as in FIG. 20. These elements can be glued or clamped to tube 120. In order to hold retraction mechanism 132 snuggly against the cap 124, after a desired length of leash is played out, a sliding clamp 134 provided on leash line 133 is slid into place against end cap 126 and the wand is ready for use.

Although the present invention has been shown and described above with reference to several specific embodiments, it is anticipated that many alterations and modifications thereof will no doubt become apparent to those skilled in the art. It is therefore intended that the following claims be interpreted as covering all such alterations and modifications as fall within the true spirit and scope of the invention.

1. A dog training and control apparatus, comprising:
an elongated walking wand having a distraction end and a handle end; and
guide means for receiving and holding a leash in place along at least a substantial part of the length of said wand;
whereby a leash can be strung through said guide means, one end of the leash can be secured to said wand proximate said distraction end, and the distal end of the leash can be routed past said handle end attached to the collar of a dog to be trained, such that a handler gripping said wand at said handle end can use the leash to restrain the dog in a heeling position, and can use the distraction end to distract the dog should it attempt to move forward of the heeling position or have its attention diverted.

2. A dog training and control apparatus as recited in claim 1 wherein said guide means is formed by at least two leash receiving guide rings, a first of which is attached to said wand proximate said handle end, and a second of which is attached to said wand along a mid portion of the length thereof.

3. A dog training and control apparatus as recited in claim 1 and further comprising:
a distraction means affixed to said distraction end of said wand, said distraction means being selectively used to further distract the dog should it attempt to move forward of the heeling position or have its attention diverted.

4. A dog training and control apparatus as recited in claim 3 wherein said distraction means is a noise maker.

5. A dog training and control apparatus as recited in claim 4 wherein said noise maker is a rattle formed by a metal or plastic container partially filled with small objects that make noise when said container is shaken.

6. A dog training and control apparatus as recited in claim 4 wherein said noise maker includes an electrically operated sound generator actuated by touching the dog.

7. A dog training and control apparatus as recited in claim 3 wherein said noise maker includes an electrically charged probe that will impart a small shock to the dog when it placed in contact with the dog's skin.

8. A dog training and control apparatus as recited in claim 1 wherein said wand is a made of a tubular material capped at each end, and wherein said guide rings are Carabineer rings affixed to said tubular material by passing through holes provided therein.

9. A dog training and control apparatus as recited in claim 1 wherein said wand includes an elongated first member telescopically received within an elongated second member and movable relative to said second member between a retracted position and an extended position, and means for selectively locking said first member in a selected position relative to said second member whereby the length of said wand can be adjusted.

10. A dog training and control apparatus as recited in claim 9 and further comprising:
a dog distraction means affixed to said distraction end of said wand, said dog distraction means being selectively used to further distract the dog should it attempt to move forward of the heeling position or have its attention diverted.

11. A dog training and control apparatus as recited in claim 10 wherein said distraction means includes an electrically charged probe that will impart a small shock to the dog when it placed in contact with the dog's skin.

12. A dog training and control apparatus as recited in claim 10 wherein said noise maker includes an electrically operated sound generator actuated by touching the dog.

13. A dog training and control apparatus as recited in claim 1 and further comprising a hand receiving safety loop affixed to the handle end of the wand to assist the user in holding the apparatus.

14. A dog training and control apparatus as recited in claim 9 and further comprising a hand receiving safety loop affixed to the handle end of the wand to assist the user in holding the apparatus.
